(19) United States
(12) Patent Application Publication
(10) Pub. No.: US 2023/0241877 A1
(43) Pub. Date: Aug. 3, 2023

(54) EQUIPMENT AND METHOD FOR LAYING A FILM ON A PLATE-SHAPED PART HOLDER

(71) Applicant: PBMC SA, Les Brenets (CH)

(72) Inventors: Denis MUNIER, Villers-le-Lac (FR); Doniphan MOLLARD, Le Bizot (FR); Eric PERRIER, Dizy (CH)

(21) Appl. No.: 18/105,600

(22) Filed: Feb. 3, 2023

(30) Foreign Application Priority Data
Feb. 2, 2022 (CH) CH000099/2022

(51) Int. Cl. B32B 37/00; B32B 38/00; B32B 41/00; B32B 3/26; B32B 37/18

(52) U.S. Cl. CPC B32B 37/0053; B32B 38/0004; B32B 41/00; B32B 3/266; B32B 37/18; B32B 2307/7166; B32B 2309/68

(57) ABSTRACT

The invention relates to an equipment having an upstream holder for a supply reel carrying a continuous ribbon, a portion of which is suitable for forming a film intended to cover a support plate, a downstream holder, an assembly station having a base comprising having a first platen, an actuator with a movable part carrying a second platen, the second platen or the first platen being adapted to receive a support plate, wherein the second platen is adapted to cooperate with the first platen to form a tooling capable of contacting the film and the support plate when the portion of the ribbon forming the film is located between the second platen and the first platen, facing the support plate.

The present invention relates to an equipment and a method for placing a film on a support plate having through openings, in particular a plate forming a part holder.

Such support plates have through openings and can be used to hold and separate flat parts from each other, thus forming a part holder. Such support plates thus allow the common treatment of a series of flat parts in a treatment machine, for example in a single-sided or double-sided treatment machine.

Single or double sided treatment machines allow to perform different treatment operations on the flat surface of a part, metallic or not, aiming in particular at rectifying the flatness, the surface finish and/or the dimensions of the part. Among these techniques, we can mention:
polishing, i.e. achieving the reduction of the roughness of a surface,
lapping, i.e. finishing by abrasion of a part so that it has a smooth and polished surface, and has a precise shape,
grinding, i.e. the removal of material achieved by a large number of abrasive grains, sometimes agglomerated, which act as a cutting tool,
resurfacing, i.e. a machining operation carried out by means of fine abrasives, which makes it possible to bring a part or a part of a part to a precise dimension within a tight tolerance and to obtain an excellent surface condition which will have a low coefficient of friction,
thickness adjustment, . . . .

These treatment machines include, but are not limited to, grinding or resurfacing, lapping and polishing machines.

The invention therefore concerns the treatment of parts, in particular, but not limited to, the treatment in one of these machines of metal parts, in particular parts made of steel (stainless steel or not), copper alloys, titanium, aluminium alloys, tungsten carbides, precious metals, but also flat parts made of other materials, and in particular of glass, crystals, ceramics, composites, synthetic materials, natural materials such as natural stones.

Such parts are for example flat parts for the watch industry (bridge, plate, gear, pinions, dial, cam, index . . . ) or flat parts for the automotive, aeronautical, or medical fields.

### STATE OF THE ART

WO2019229585 describes of a part loading assembly in a single or double-sided treatment machine, using a plate-like part holder for holding at least one part. The part holder delimits at least one through opening forming a cell for housing at least one part to be treated, and a film mounted on the first face of the part holder facing said through opening and allowing said part to be held in said opening at least during the loading step.

Thus, a temporary support film is used to hold the parts placed in the windows of the part holder during loading. This film then disappears during the treatment of the parts, the parts remaining in the cells of the parts holder until the end of the treatment. The use of this support film, which forms a temporary bottom for the cells of the part holder, makes it possible to place the parts in the part holder outside the treatment machine, thus reducing the time required to load the parts into the machine to the simple placement of the part holder already filled with parts to be processed.

To date, there is no equipment for applying such a film to a part holder consisting of a support plate with through openings or cells. The application of such a film, and in particular of a soluble film, preferably water-soluble or liposoluble, is currently possible manually. The use of this temporary bottom will, in particular, save time for loading the parts into a treatment machine, thus reducing the downtime of the treatment machine and thus saving money. However, when the operation of mounting each film on a part holder is a completely manual operation, it generates costs that could be reduced with an equipment capable of simplifying the operation and reducing its implementation time.

### BRIEF SUMMARY OF THE INVENTION

It is an object of the present invention to provide an equipment and method for laying a film on a support plate that makes this film placing operation easier and more reliable.

Another purpose of the invention is to provide an equipment and method for laying a film on a support plate that allows for a faster implementation of the film putting up operation than a completely manual application procedure.

According to the invention, these aims are achieved in particular by means of an equipment for laying a film on a support plate having through openings, said equipment comprising:
an upstream holder suitable for serving as an axis for a supply reel carrying a continuous ribbon, a portion of which is suitable for forming a film intended to cover said support plate,
a downstream holder suitable for serving as an axis for a reel for recovering the remaining portion of the continuous ribbon after separation of the film from the continuous ribbon,
an assembly station disposed between the upstream holder and the downstream holder, said assembly station comprising:
   a base comprising a first plate,
   an actuator with a movable part carrying a second platen connected to the free end of the movable part,
      the second platen or the first platen being adapted to receive a support plate,
      wherein the movable part is adapted to move reversibly from a first position, in which the second platen is spaced from the first platen to a second position, in which the second platen rests on (is in abutment with) said first plate, and
      in which the second platen is capable of cooperating with said first platen, in said second position of the movable part, to form a tooling capable of bringing said film and said support plate into contact when the portion of the ribbon forming the film is situated between the second platen and the first platen, opposite said support plate.

This solution has the advantage, compared to the previous art, of allowing a more precise and reliable application of the film on each support plate with a saving of time compared to an entirely manual operation.

In fact, it is understood that the film arrives from the supply reel placed on the upstream holder at the location between the first platen and the second platen. At the same time, the support plate is retained on the free face of the first platen or the second platen. The movement of the actuator moves from a first position of the first platen in which the first platen is spaced from the second platen, allowing placement of the ribbon with the portion to form the film facing the first platen and placement of the support plate on the first platen or the second platen, to a second position of the first platen in which the film and the support plate are sandwiched between the first platen and the second platen.

For this purpose, the actuator is close to the base so that the arrangement of the base and the actuator allows contact between the first platen and the second platen in the second position of the movable part of the actuator.

Thus, after mounting the film on the support plate provided with through openings, this support plate having to serve as a support for parts during the treatment of these parts, it now forms a plate-shaped part holder provided with a bottom for each through opening which now delimits a cell that can accommodate one or more parts. It is understood that this cavity has the film as a bottom, and that the side walls of this cavity correspond to the portion of the support plate bordering a through opening, the other side of this cavity being open on the face of the support plate opposite the face to which the film is attached.

The film is a portion of the ribbon supported by the supply reel, which portion will form the temporary bottom of the support plate forming the part holder, and also called satellite in particular in the field of watchmaking. For this purpose, the film is a portion such that it covers the support plate in whole or in part. It is understood that the film covers at least all the through openings, on one of the faces of the support plate, to form cells with the film as a bottom, these cells being open on the other side opening onto the face of the support plate not covered by the film. The film-covered support plate can then be used as a temporary support for the parts to be processed, which are placed one by one or several in each cell. Since the preparation of this temporary carrier filled with parts can be carried out in advance and outside the treatment machine, it is sufficient to put these filled temporary carriers on standby until the time of treatment: the time required for placing each support plate with film and parts in the treatment machine is thus much shorter than placing the support plate in the treatment machine and then placing each part one by one in the through openings of the support plate as before.

According to one arrangement, the base comprises a first platen delimiting a footprint whose contour has a shape that can cover at least all the through openings of the support plate. Thus, this footprint is a visual mark, possibly in relief (recessed or protruding), for positioning the film on the first platen and possibly contributing to the delineation and separation of the film from the ribbon when placing the film on the support plate. This also ensures that the shape and size of the film will allow the film to cover all of the through openings in the support plate and thus serve as a temporary bottom to all of the through openings in the support plate.

According to another arrangement, the second platen delimits a footprint whose contour is superimposable on the contour of the footprint of the first platen, with contact between the contour of the footprint of the second platen and the contour of the footprint of the first platen in said second position of the movable part. Thus, it is understood that upon contact between the first platen and the second platen, the contour of the footprint of the first platen coming into contact with the contour of the footprint of the second platen, this contact will facilitate the cutting and separation of the film from the ribbon when the film is placed on the support plate.

According to yet another arrangement, the second platen is removable and the first platen is removable. Thus, a set of pairs of first and second platens (e.g., a top platen and a bottom platen) may be defined, each pair being adapted to a size and/or shape of support plate. In the case of the foregoing arrangement, each pair comprises a first platen and a second platen, the first platen defining a footprint with a contour superimposable on the contour of the footprint of the second platen, said contour having a different size and/or shape in each pair.

The present invention also relates to a method of applying a film to a support plate having through openings, comprising the following steps:
a support plate is provided forming a plate-shaped part holder,
   a supply reel is provided carrying a continuous ribbon, a portion of which is suitable for forming a film intended to cover said support plate,
an equipment is provided, said equipment comprising:
   an upstream holder on which said supply reel is mounted
   a downstream holder on which is mounted a collecting reel able to receive the remaining portion of the continuous ribbon after separation of the film from the continuous ribbon
   an assembly station disposed between the upstream holder and the downstream holder, said assembly station comprising:
a base comprising a first plate,
an actuator with a movable part,
a second platen connected to the free end of the movable part,
   wherein the movable part is adapted to move reversibly from a first position, in which the second platen is distant from the first plate, to a second position, in which the second platen rests on said first plate, and
   wherein the second platen is adapted to cooperate with said first plate, in said second position of the movable part in order to form a tooling able to contact said film and said support plate,
the mobile part is placed in said first position,
said support plate is mounted on the second platen or the first platen,
the continuous ribbon is placed so that the portion of the ribbon forming the film is located between the second platen and the first plate, (this step and the previous one can be reversed as to their order of implementation),
the movable part is placed in said second position, whereby the support plate and the film come into contact with each other and a support plate covered with the film is obtained,
   the movable part is placed in said first position and the film-covered support plate is released from said assembly station.

Then, the operations are repeated, starting from the step of placing the movable part of the actuator in the first position, and continuing with a new support plate and the advancement of the ribbon to have a new film opposite the area where the free face of the support plate will be in the second position of the movable part of the actuator.

This results in a partially or fully mechanized procedure, whereby some of the steps in this film application process can remain manual with other steps mechanized or even automated, or all steps in this process can be automated.

In this method of placing film on a support plate, one or more of the following provisions may be implemented:
before placing the portion of the ribbon forming the film between the second platen and the first platen, a discontinuous pre-cut line is made in the ribbon, said discontinuous line following the contour of said film in a shape suitable for covering the support plate;
wherein said continuous ribbon comprises a first layer of a first water-soluble or fat-soluble material covered with a second layer of a second material which is non-adhesive to itself and to the first material, said ribbon being arranged such that the first material is suitable for facing the support plate;
said equipment further comprises a humidification unit located in the vicinity of the assembly station, and adapted to wet the face of the film facing the support plate, or adapted to wet the free face of the support plate when said support plate is mounted on the first platen or on the second platen and when the movable part is in said first position;—
said first platen has passages opening on its side facing the second platen, said equipment further comprising a system for maintaining the position of the film on the support plate by means of vacuum, comprising a suction unit connected to said passages of the first platen, and, prior to placing the movable part in said second position, said suction unit is activated, whereby the position of the film on the first platen is maintained, and the activation of said suction unit is maintained while the movable part is in said second position;—
said actuator with a movable part is an actuator with a linearly moving piston, said movable part comprising said piston, said actuator being disposed opposite facing the base, said actuator defining a longitudinal axis intersecting with the first platen and disposed orthogonally with the first platen, wherein said second platen is connected to the free end of the piston rod

### BRIEF DESCRIPTION OF THE FIGURES

Non-limiting embodiments of the invention are set out in the description, which is illustrated by the attached figures, in which:

FIG. 1 is a general perspective view of the equipment according to a first embodiment of the invention,

FIG. 2 is a front view of the equipment of FIG. 1, with the ribbon in operational position allowing the film to be applied,

FIG. 3 is a view identical to FIG. 2, when the support plate is mounted, with the movable part of the actuator in the first position,

FIG. 4 is a partial view of the equipment, showing the mounting of the support plate,

FIG. 5 is a perspective view of the support plate before the film is applied,

FIG. 6 is a view identical to FIG. 2, with the movable part of the actuator in the second position,

FIG. 7 is a perspective view of the support plate, after the film has been applied, from the side of the support plate with the film, with the film in semi-transparency,

FIGS. 8A to 8D show the principle of mounting the film on a variant of a support plate, to form a loading assembly seen from its front side (FIGS. 8A, 8B and 8C) and from its rear side once the film has been laid (FIG. 8D), and

FIG. 9 is a front view of the equipment according to a second embodiment, when the support plate is mounted on the first platen.

### EXAMPLE(S) OF EMBODIMENT OF THE INVENTION

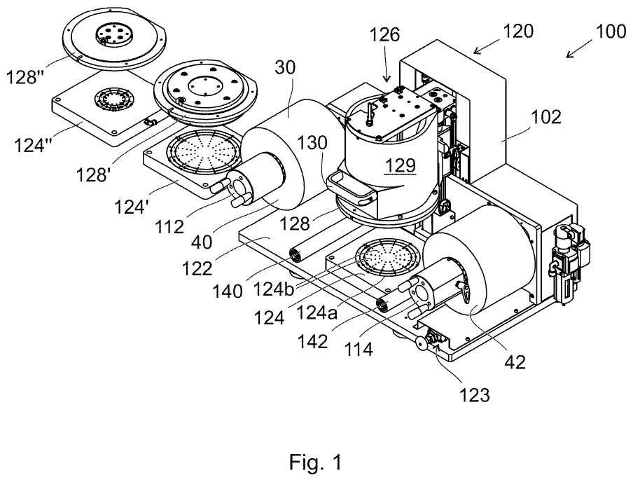

A first embodiment of the equipment 100 according to the present invention is shown in FIGS. 1 to 4 and 6. This equipment 100 includes an assembly station 120 mounted on a frame 102. The frame 102 carries an upstream holder 112 and a downstream holder 114. The upstream holder 112 carries a supply reel 40 carrying a continuous ribbon (or tape) 30 wound upon itself. The downstream holder 114 carries a collecting reel 42 capable of receiving the continuous ribbon 30 after it has passed through the assembly station 120, once the portion of the ribbon 30 forming the film is mounted on the support plate. The upstream holder 112 and the downstream holder 114 are placed on either side of the assembly station 120, their axis being parallel to each other, so that after separation of the film from the continuous ribbon, the remaining portion of the continuous ribbon can be wound on the collecting reel 42. The upstream holder 112 and the downstream holder 114 can be rotated manually or by control means, such as a motor, activated manually or automatically. According to one embodiment not shown, the upstream holder 112 and the downstream holder 114 are not mounted on the frame 102, but are arranged separately while forming part of the equipment 100.

The assembly station 120 is disposed between the upstream holder 112 and the downstream holder 114. The assembly station 120 comprises a base 122 on which a first platen 124 is mounted: in this first embodiment, it is a fixed lower plate 124 and a fixed base 122, these two elements therefore not being mobile. The assembly station 120 comprises an actuator 126, opposite the base (above the base 122 in the embodiment shown), with a movable part 129 at the free end of which is mounted a second platen 128 forming an upper platen.

In this embodiment, the actuator 126 is an actuator and the movable part 129 of the actuator 126 comprises a piston with linear motion. This actuator 126 is disposed opposite facing the base 122, said actuator defining a longitudinal axis (here vertical) intersecting with the first platen 124 mounted on the base 122, this axis being disposed orthogonally with the first platen 124. In the configuration adopted in the figures, this axis passes through the center of the footprint 124a of the first platen 124, defined below. Furthermore, the second platen 128 is mounted on the free end of the piston rod, and is removable for interchangeability with another platen 128′ or 128″. The actuator 126 (here the cylinder) is for example pneumatically actuated, other types of actuation remaining possible.

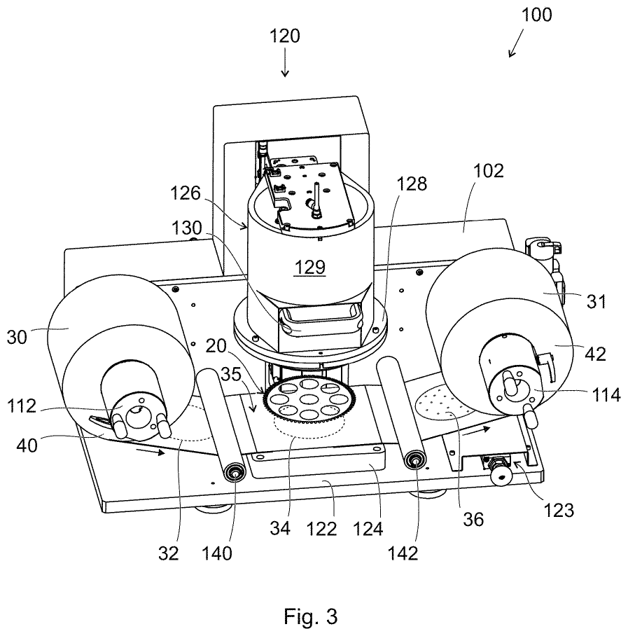

According to one embodiment of the depicted first embodiment, the up and down movement of the movable part 129 (piston) of the actuator 126 (herein the cylinder) is triggered by an operator acting on a handle 130. According to another implementation possibility of the first embodiment shown, the downward movement of the movable part 129 (piston) of the actuator 126 (here the cylinder) is triggered by an operator acting on a handle 130 and the upward movement is actuated by a motorized system. According to another possibility of implementation of the first embodiment shown, the upward movement of the movable part 129 (piston) of the actuator 126 (here the cylinder) is triggered by an operator acting on a handle 130 and the downward movement is actuated by a motorized system. According to one possibility of implementation of the first embodiment shown, the lowering movement of the movable part 129 (piston) of the actuator 126 (here the cylinder) is performed in one sequence, and according to another possibility, the lowering movement of the movable part 129 (piston) of the actuator 126 (here the cylinder) is performed in two sequences (in two times). Indeed, according to a variant, the descent of the mobile part 129 (piston) of the actuator 126 (here the jack) can be carried out in two steps in order to, in the first place, bring the first platen 124 and the second platen 128 closer to each other, and then, in the second place, to put them in contact with each other. This contact can be carried out with a pressure of at least 1 bar, for example between 1 bar and 5 bars, or between 1 bar and 10 bars, or even between 1 bar and 20 bars, for a minimum duration, for example of at least 5 seconds, or even of at least 10 seconds, or even of at least 30 seconds. The value of the pressure exerted between the first platen 124 and the second platen 128 and the duration of this pressurization depend on how quickly the film 34 is attached to the support plate, and especially on the structural strength (fragility) of the support plate 20. For example, particularly in the case of small support plates, the movable part 129 of the actuator 126 is arranged so that when the second platen 128 is in contact with the first platen 124, the second platen 1128 exerts a pressure of at least 1 bar, and in particular of between 1 and 5 bar at the maximum. The first part of the descent may allow the first platen 124 and the second platen 128 to be brought sufficiently close together to allow the portion of the ribbon 30 intended to form the film 34 to be held in the correct position, or even to be able to still return this portion of the ribbon to the correct position aligned with the support plate 20. It can be seen from FIG. 3 that in the case of a support plate 20 and a film 34 that are both circular, the correct position between them before the film 34 is cut and fixed corresponds to a concentric position between the support plate 20 and the film 34.

This first platen 124 and this second platen 128 are of a first design and are paired, forming a pair of platens between them that cooperate to allow removal and separation of the film 34 from the remainder of the continuous ribbon 30, and then contact of the film to the support plate, as will be explained later.

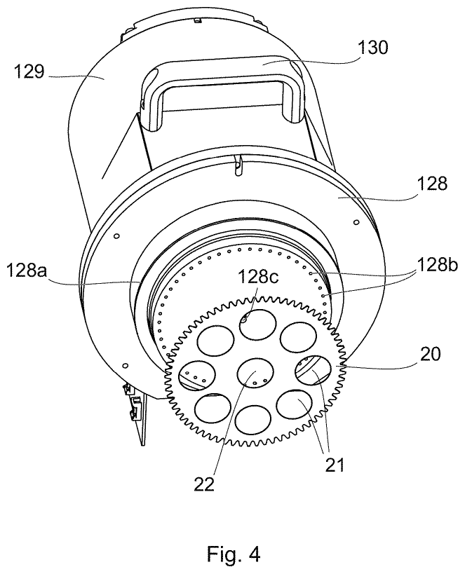

To this end, the first platen 124, includes on its free face a circular footprint 124a (An imprint for example in the form of line(s), groove(s) or rib(s) or recessed or projecting disk) whose contour corresponds to the contour of the film 34 to be placed on the support plate, as can be seen in FIGS. 1 and 3. In parallel, as can be seen in FIG. 4, the second platen 128 has on its free face an footprint 128a that is also circular, of the same size as the footprint 124a of the first platen 124, for example in the form of a groove or rib or recessed or projecting disk. In FIGS. 1 and 4, it can be seen that the footprint 124a is formed of concentric lines formed of grooves and that the footprint 128a is formed of a circular face whose edge is superimposable on the contour of the footprint 124a. In this illustrated example, the footprints 124a and 128a which correspond to each other (their contour is superimposable) are circular but other shapes are possible, in particular but not limited to an oval, ovoid, square, triangular rectangular or other polygonal shape.

In FIG. 1, two other pairs of platens are shown next to the frame. Indeed, in this embodiment, the first platen 124 and the second platen 128 are removable. Thus, one or the other of the first platens 124, 124′ and 124″ can be mounted on the base 122, and in parallel the corresponding second platen 128, 128′ or 128″ can be mounted on the lower end of the piston of the actuator (or more generally the free end of the movable part 129 of the actuator 126). The other first platen 124′ and the other second platen 128′ are of a second model and are paired, forming between them a second possible pair of platens for the equipment, these two platens 124′ and 128′ cooperating for the application of a film another type of support plate (not shown): here the footprint of the first platen 124′ and of the second platen 128′ of this second pair is larger than the footprint of the platens 124 and 128 of the first pair. This second pair is used for a larger film to be mounted on a larger support plate than when using the first pair of platens 124 and 128. On the left side of FIG. 1 are shown another first platen 124″ and another second platen 128″, both of a third model and paired, forming between them a third possible pair of platens for the equipment, these two platens 124″ and 128″ cooperating for the application of a film another type of support plate (not shown): here the footprint of the first platen 124″ and of the second platen 128″ of this third pair is smaller than the footprint of the platens 124 and 128 of the first pair. This third pair is used for a smaller film to be mounted on a smaller support plate than when using the first pair of plates 124 and 128.

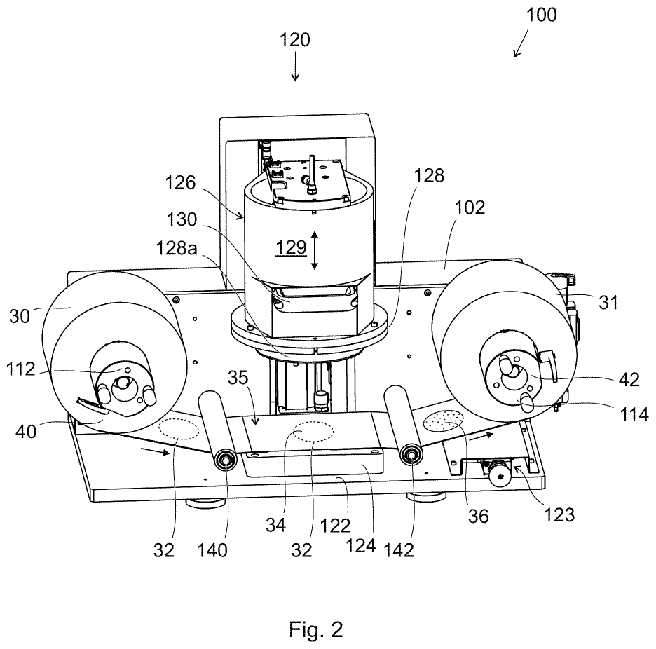

As can be seen in FIGS. 1-3, 6 and 9, the upstream holder 112 carries a supply reel 40 carrying a continuous ribbon 30 comprising the film 34 for attachment to the support plate. 20. For this purpose, preferably, said ribbon 30 is pre-punched along at least one line of pre-cuts 32 delimiting the contour of the film 34. According to a first possibility, visible in FIGS. 2, 3 and 6, the ribbon 30 is provided with pre-cut lines 32 made in advance along the entire continuous ribbon 30 arranged on the supply reel 40. According to a second possibility, not shown, the supply reel 40 mounted on the upstream holder 112 carries a continuous ribbon 30 without a pre-cut line 32 and the equipment 100 further comprises a pre-cutting station, arranged between the upstream holder 112 and the assembly station 120, comprising cutting means arranged to allow the realization of a discontinuous line of pre-cuts in the ribbon 30, said discontinuous line of pre-cuts 32 following the contour of said film 34 according to a shape suitable to cover the support plate 30. In both cases, the distance along the ribbon between two consecutive pre-cuts lines 32 and the dimensions of this or these pre-cuts lines 32 are adapted to the model of the pair of platens 124, 128 (124′+128′; 124″+128″, or other) and to the model of support plate 20 to be processed.

The downstream holder 114 carries a collecting reel 42 on which the remaining continuous ribbon 30, without the film 34, forming a filmless ribbon 31, is wound for recovery. As the ribbon 30 advances from left to right in FIGS. 1 to 3, 6 and 9, rotating the downstream holder 114 (on the right in FIGS. 1 to 3, 6 and 9), either manually or by a rotation mechanism, allows the ribbon 30 to advance between two operations of laying a film 34 on a support plate 20.

According to the respective materials used for the support plate 20 and for the film 34, the film 34 is attached to the face of the support plate 20 by gluing, welding, or by static electricity, molecular adhesion, capillarity . . . .

According to one arrangement, the continuous ribbon 30 comprises two superimposed layers: a first layer 35 of a first material covered by a second layer 36 of a second material. The film 34 consists of only the first layer 35, thus only the first material.

The first material is a material that is easily degradable by friction or by contact with a liquid, in particular a material that is soluble in a liquid, preferably a water-soluble or fat-soluble material, such as a water-soluble or fat-soluble plastic. Examples of a water-soluble material for forming the film include polyvinyl acetate (PVA) or polyvinyl alcohol (PVAL), or another water-soluble resin, or a mixture of these water-soluble materials.
The second layer 36 serves as a support and protection for the first layer 35. This second layer 36 is made of a second material that is non-adherent to itself and also non-adherent to the first material. This second layer 36 serves as a protection and support for the first layer, which alone will form the film. Within the equipment 100, the ribbon 30 is arranged so that the first material (the first layer 35) is able to face the support plate 20, including in the second position of the moving part 129 of the actuator 126. As seen in the figures, the continuous ribbon 30 is placed so that the portion of the ribbon that will form the film 34 to be placed on the support plate 20, is located between the second platen 128 and the first platen 124 facing the support plate 20, with the first layer 35 of said portion of the ribbon 30 directly facing the support plate 20. The second layer 36 of the ribbon 30 will remain integrally on the section 31 of the ribbon without the films 34, said films having been detached from the ribbon 30 and remained one by one on a support plate 20, with this section 31 and the second layer coming on the collecting reel 42.

In the first embodiment, the support plate 20 is placed on the second platen 128. In this configuration, as can be seen in FIGS. 3 and 4, with the second platen 128 forming an upper platen, the support plate 20 must be retained under the second platen 128 before and during the descent of the second platen 128 and the movable part 129 of the actuator 126 (piston of the cylinder), and then release the support plate 20 from the second platen 128 when the second platen 128 and the second platen 124 are pressed together, namely when the support plate 20 and the film 34 are brought into contact.

To this end, the second platen 128 includes passages 128b between its two faces (see the openings in FIG. 4), and the assembly station 120 includes a system for retaining the support plate by vacuum, including a suction unit (not visible in the figures) connected to said passages 128b, said retaining system being capable of allowing the support plate 20 to be held on the second platen 128 when said suction unit is activated. This system for retaining the support plate 20 by vacuum is sufficient to retain the support plate 20 of low mass, and it is sufficient to stop the suction through the passages 128b for the support plate 20 to be released from the second platen 128 and to descend by gravity.

To facilitate the correct positioning of the support plate 20 on the second platen 128, as can be seen in FIG. 4, the free face (lower face) of the second platen 128 has a centring pin 128c that cooperates in a form-fitting manner with a centring hole 22 arranged in the center of the support plate 20.

In the illustrated embodiment of the first embodiment, a suction or vacuum is also used to hold the portion of the ribbon 30 forming the film 34 (precut disk along the pre-cut line 32 of the first layer 35 in the figures) in position against the footprint 124a of the first platen 124 (see FIGS. 1 and 3). To this end, the first platen 124 has passages 124b between its two faces. These passages 124b open onto the face of the first platen 124 facing the second platen 128 (see openings 124b in FIG. 1). The equipment 100 further comprises a system for holding the position of the film 34 on the support plate 20 by vacuum, comprising a suction unit 123 connected to said passages 124b of the first platen, said holding system being capable of allowing the position of the film 30 on the first platen 124 to be held when said suction unit 123 is activated. In order to guide the ribbon 30 in the area in which the film 34 will be applied to the support plate 20, opposite the first platen 124 (above the first platen 124 in the figures), the equipment 100 includes two guide rollers 140, 142, mounted on the frame 102 in the illustrated examples. These two guide rollers 140, 142 include an upstream guide roller 140 disposed parallel to the upstream holder 112, between the upstream holder 112 and the base 122, and a downstream guide roller 142 disposed parallel to the downstream holder 114, between the downstream holder 114 and the base 122.

As seen in FIGS. 1-3, 6 and 9, these guide rollers 140, 142 are located on opposite sides of the base 122/first platen 124, to force the ribbon 30 to pass over, and in close proximity to, the free face of the first platen 124, with the second layer 36 facing the first platen 124.
It can be seen, for example, that the lowermost generatrix of the two guide rollers 140, 142, is located below the plane passing through the free face (top face) of the first platen 124 (lower platen) or below and preferably within 1 centimeter of said plane passing through the free face (top face) of the first platen 124 (lower platen).

We now describe the implementation of the method of laying the film on the support plate with this first embodiment of the equipment 100 in which the first platen 124 carrying the support plate 20, is fixed.

Step 1: the supply reel 40 carrying the ribbon 30 is placed on the upstream holder 112 and the empty collecting reel 42 is placed on the downstream holder 114. Then the ribbon 30 is advanced by allowing the rotation of the upstream and downstream holders 112 and 114, so that the portion forming the film 34 is well placed, facing the first platen 124 mounted on the base 122: this is the centring of the film 34 pre-cut in the ribbon 30 with respect to the footprint 124a of the first platen 124 (see the arrows showing the advance of the ribbon 30 on FIG. 2);

Step 2: the suction unit 123 is activated, with the negative pressure of the passages 124b through the first platen 124 drawing the ribbon 30 against the first platen 124, which maintains the correct positioning of the ribbon on the footprint 124a of the first platen 124. In this arrangement, the first layer 35 of the ribbon 30 faces upward toward the second or top platen 128, and it is the second layer 36 of the ribbon that is held in contact against the top face of the first platen 124. This is the stabilization of the portion of the ribbon 30 carrying the film 34 (see FIG. 2). Thus, the first layer 35 of the ribbon 30 directly faces the support plate 20;

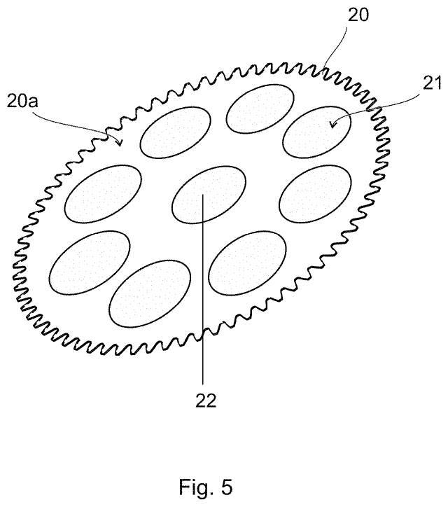

Step 3: the entire first face 20a of the support plate 20 to be covered is moistened, i.e. wetted with liquid, and in particular with a water spray (see FIG. 5): this moistening step can be carried out when the support plate 20 is already mounted on the second platen 128 or prior to this mounting,

Step 4: the support plate 20 is positioned on the second platen 128, with its second face 20b facing the second platen 128, by placing the centring hole 22 of the support plate on the centring pin 128c of the second platen 128 (see FIGS. 3 and 4). The support plate 20 is then accommodated in a centered manner on the circular footprint 128a of the second platen 128. At the same time, the support plate 20 retaining system is activated by activating the operation of the suction unit connected to the passages 128b of the second platen 128, which allows the support plate to be held under the second platen 128;

Step 5: the movable part of the actuator, namely in this case the piston 129 of the cylinder 126, is lowered, for example by lowering the handle 130, and this until the contact between the first platen 124 and the second platen 128 (FIG. 6). According to one possibility (see FIG. 4), the plate 128 comprises an external ring surrounding a central portion delimited by the footprint 128a and the descent of the piston and of the second platen is carried out in two stages: in a first stage, the whole plate 128 descends with the piston 129 until the moment when it makes it possible to retain the ribbon 30, then in a second stage, the external ring remaining immobile, only the central portion of the second platen 128 descends until contact with the first platen 124;

Step 6: the retaining system of the support plate 20 is deactivated by stopping the operation of the suction unit connected to the passages 128b of the second platen 128, which allows the release of the support plate 20 from the second platen 128, the support plate being placed against the film 34 both positioned in a centered manner (concentric in the figures) with respect to each other. For example, the arrival of the second platen 128 in its lower position is detected by detecting a contact between two other elements.

Step 7: a pressure of the order of a few bars is maintained between the second platen 128 and the first platen 124 via the cylinder 126, and this for a time of the order of a few seconds. During this time, the film 34 adheres to the first face 20a of the support plate 20 by contact between the liquid present on this first face 20a of the support plate 20 and the film 34;

Step 8: the mobile part of the actuator, namely in this case the piston 129 of the cylinder 126, is raised, for example by activating the rising either automatically or manually by the handle 130. This rising step can be carried out in a continuous sequence (a single step) or in two steps. At the beginning of this step, the film 34 is stuck to the support plate 20, and is no longer connected to the rest of the ribbon 31 from which it has been detached, while still being positioned against (here above) the second layer 36. At the end of this step, the second platen 128 is in its second high position, and the ribbon 30 no longer comprises anything but the second layer 36 in the portion that served to form the film 34;

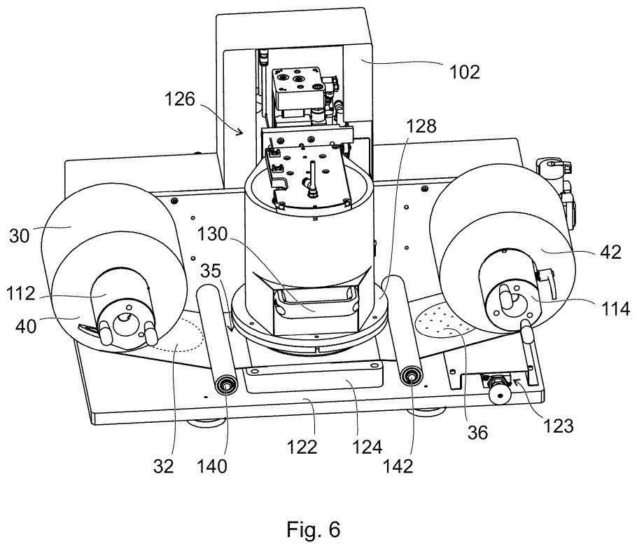

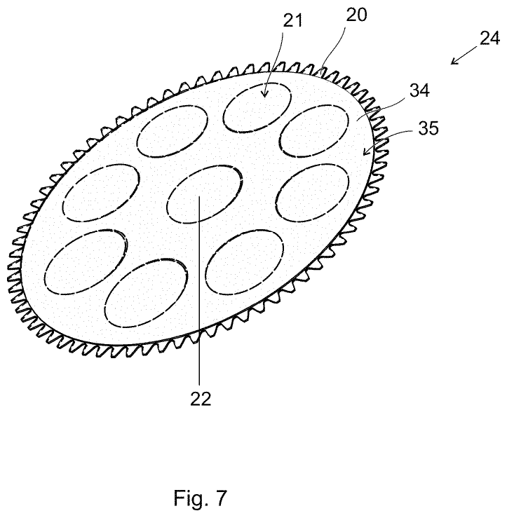

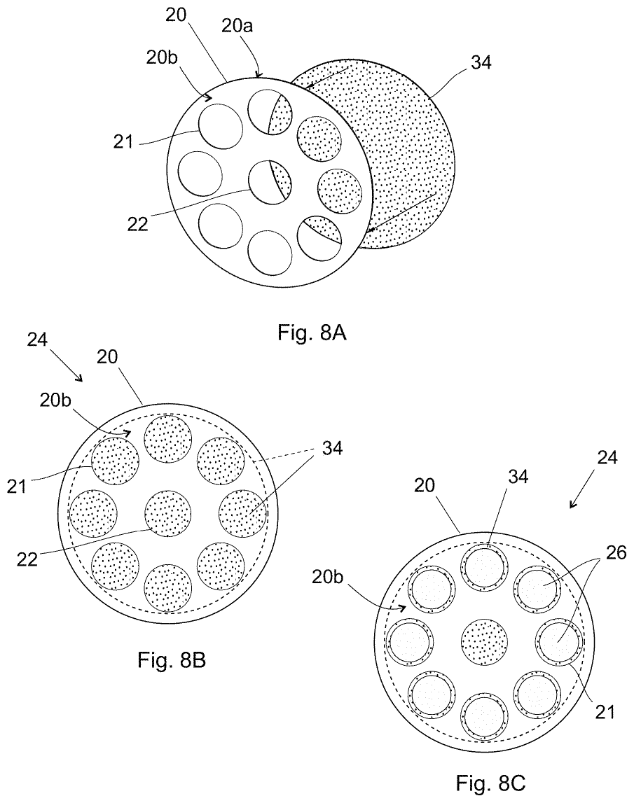

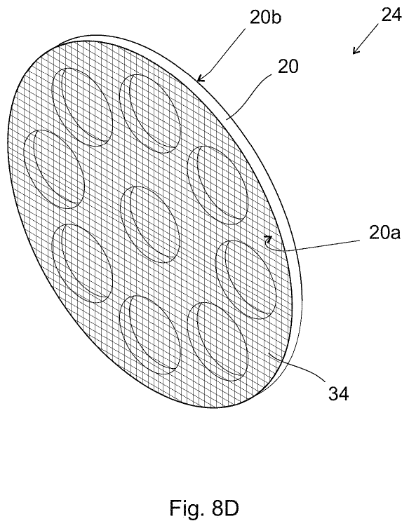

Step 9: the support plate 20 coated with the film 34 is unloaded, forming a loading assembly 24 for parts to be processed/treated 26 (FIGS. 7 and 8c).

The stopping of the suction unit 123 connected to the first platen 124 takes place during step 7 or during step S, as long as the suction unit 123 is activated, the portion of the second layer 36 of the ribbon 30 that was facing the film 34 remaining pressed against the first platen 124 and thus facilitating the separation and subsequent removal of the film 34 from the ribbon 30. This takes place in the form of the separation of a portion of the first layer 35 from the second layer 36, along the pre-cut line 32.

The film-covered support plate 24 can be removed from the equipment 100 manually, or automatically. In the latter case, for example, the equipment 100 further comprises an unloading unit (not shown) adapted to take said film-covered support plate 20 (forming a loading assembly 24) out of said assembly station 120 when the movable part 129 of the actuator 126 (piston rod of the cylinder) has returned to the first (raised) position.

Similarly, the support plate 20 can be placed in the assembly station 120 manually or automatically. In the latter case, for example, the equipment 100 further comprises a loading unit (not shown) adapted to bring a support plate 20 into said assembly station 120 on the second platen 128 (upper platen for the first embodiment) or on the first platen 124 (lower platen for the second embodiment), when the movable part 129 of the actuator 126 (piston rod of the actuator) is in the first (raised) position (and with the movable part 125 of the actuator in a resting position, retracted for the second embodiment).

The support plate 20 is a part holder whose through openings 21 form cells capable of holding one or more parts 26. This support plate is for example a satellite, used in particular for polishing flat parts 26 in the field of watchmaking. The through openings 21 can have multiple shapes and sizes, including on the same support plate 20: in the figures these through openings 21 are circular but these through openings 21 can be oblong, oval, square, rectangular, or any other regular or non-regular polygon, in the shape of a semicircle, a portion of a circle, a moon, etc . . . . Thus, thanks to the process according to the invention, the film 34 is positioned opposite the first face 20a of the support plate 20, then is placed (FIG. 8A) on this first face 20a and finally fixed on this first face 20a. The result (FIGS. 8B and 8D) is a loading assembly 24 formed by the support plate 20 covered with the film 34, which then forms a bottom for each through opening 21 delimiting a cell which then receives a part to be treated 26 placed in the cell from the second face 20b of the support plate 20 (FIG. 8C).

The parts to be processed 26 are individually placed in the cells manually or by a dedicated module. According to one possibility of implementation, a parts loading machine (not shown) is provided comprising the equipment 100 previously described, a station for receiving parts to be processed 26 and a station for receiving support plates 20 covered with said film 34 (loading assemblies 24). These two stations form a downstream unit with respect to the equipment 100 and allow the manual or mechanized placing of the parts 26 in the cells of the support plate. In the latter case, according to a possible implementation, the parts loading machine further comprises a parts to be processed loading station adapted to pick up a support plate covered with said film 24 from the receiving station for support plate covered with said film 24, to pick up a part to be processed 26 from the parts to be processed receiving station and to place said part to be processed 26 in an opening 21 of said support plate 20 covered with said film 34. Thus, an automatically operating part loading machine is provided for placing the parts 26 on the support plate covered with said film 34.

The humidification of the support plate 20 or of the film 34 is carried out, for example, by spraying a jet of liquid in fine droplets, this liquid spray, for example water, being able to be carried out by an operator or by a dedicated module. In the latter case, the equipment 100 comprises a liquid spray unit (not shown), in particular a humidification unit, located near the assembly station 120, and capable of humidifying the face of the film 34 in the portion delimited by the pre-cuts line 32 (this portion being already placed or not facing the support plate 20) or capable of humidifying the free face of the support plate 20 (first face 20a). For wetting the support plate, this can be done when said support plate 20 is mounted on the first platen 124 or on the second platen 128, or upstream, i.e., before said support plate 20 is mounted on the first platen 124 or on the second platen 128, for example when a series of support plates 20 is arranged on a support plate supply station (not shown).

According to a possible arrangement, but not shown, the equipment 100 further comprises a vision control unit, comprising an image taking system and an image treatment and analysis system, the vision control unit being able to take views (images) of the area of the first platen 124 and/or the second platen 128

For example, such a vision control unit implemented in the case of the first embodiment as shown in the figures, allows to take views oriented in the direction of the upper face of the first platen 124 forming a lower platen, and this whether this first platen 124 is uncovered, or whether this first platen 124 is covered by the support plate 20 (these are then views of the upper face of the support plate 20), but also when the ribbon 30 passes over the support plate 20 (these are then views of the top of the ribbon 30 and of a portion of the support plate or only views of the top of the ribbon over the support plate 20 if the ribbon 30 covers the entire support plate 20 and this support plate 20 is no longer visible).
The images taken by the vision control unit can be used to locate the position of the footprints 124a of the first platen 124 and to locate the position of the pre-cut line 32 of the ribbon in order to match them (concentrically if they are circular, and/or to make them coincide, particularly if they are superimposable).

This image-taking system capable of taking images corresponds to an optical system, in particular a centered optical system, comprising a set of optical components and an image acquisition system. Such an image acquisition system makes it possible to take photographs and/or videos, and is presented for example in the form of a camera or a photographic apparatus, in particular a digital camera.

This vision control unit is preferably able to control the position of and/or to activate/deactivate one or more elements of the equipment 100, for example to position the ribbon 30 and the film 34 with respect to the position of the support plate 20 which is to receive the film 34, and this via, for example, the rotation of the upstream holder 112, or to control the elements of the equipment 100 allowing the cutting and laying of the film 34, in particular the actuator 126 (and the actuator 125 for the second mode of implementation).

Thus, this vision control unit may be able to set in motion and stop the rotational movement of the downstream holder 114, to allow the advancement of the downstream section of the ribbon 31 that no longer has the film 34, and to place a new section of the ribbon 30 having a pre-cuts line 32 on the first platen 124 (or the second platen 128 for the second embodiment).
This vision control unit may be able to control the movement of the movable part 129 of the actuator from the first position to the second position and vice versa.
This vision control unit may also be able to control any one or more of the following elements previously described: loading unit, unloading unit, suction unit connected to the first platen 124, suction unit connected to the second platen 128.

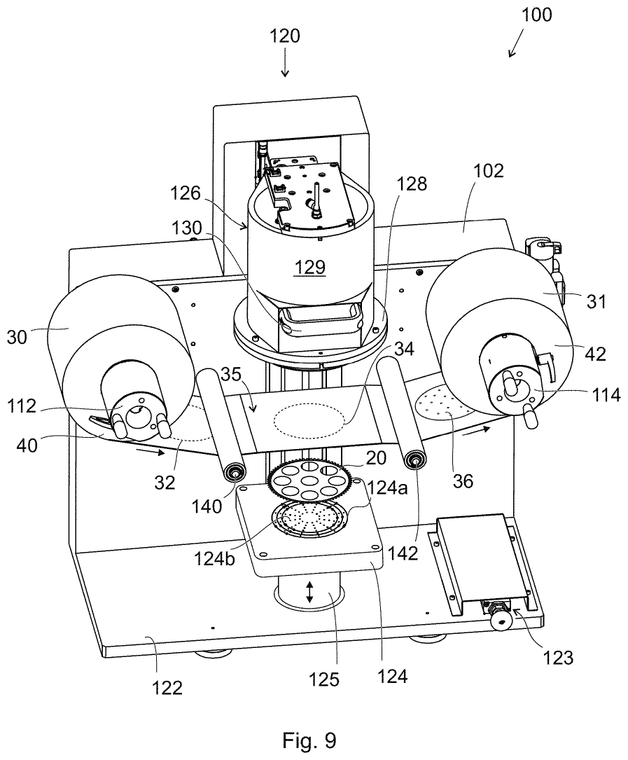

Reference is now made to FIG. 9 representing a second embodiment of the invention: the base 122 is more vertically spaced from the upstream 112 and downstream 114 holders than in the first embodiment. Thus, it is possible to raise and lower the first platen 124 that will carry the support plate 20. In FIG. 9, the first platen 124 is shown in an intermediate position, between a lower or first position, to an upper or second position. An actuator, such as a linear actuator, allows this vertical movement of the first platen, the mobile part 125 of this actuator carrying the first platen 124 at its free, upper end. The support plate 20 is in this case placed by gravity on the upper face of the first platen 124.

In the case of the second embodiment, the arrangements previously described in relation to the first embodiment remain valid except for the following:
the support plate 20 is mounted on the first platen 124, or lower platen, and is located below the ribbon 30 and the film 34,
the base 122 which carries the first platen 124, or lower plate, is not fixed but movable, from a low position or first position, spaced from the zone of passage of the ribbon 30, to a high position or second position, close to the zone of passage of the ribbon 30, with in this second position, the upper face of the first platen 124 which remains below but very close or even in contact with the portion of the ribbon forming the film 34,—
   the ribbon 30 is arranged so that the first layer 35 of the first material is turned to face the base and the first platen 124,
the second platen 128 not carrying the support plate 20, it is not necessarily provided with passages 128b connected to a suction unit and the assembly station 120 no longer necessarily comprises a plate retaining system.

More generally, according to the second embodiment of the invention in which the support plate 20 is mounted on the first platen 124, said first platen 124 is adapted to receive the support plate 20, and the base 122 is movable between a retracted position or first position, in which the first platen 124 is more than 2 centimeters away from the passage area of the section of the ribbon 30 located between the upstream holder 112 and the downstream holder 114, and an operative position or second position in which the first platen 124 is less than 1 centimeter away from said passage area. Thus, in the retracted position, the distance between the ribbon 30 and the first platen 124 ensures a sufficient distance between the support plate 20 and the ribbon 30 to allow the ribbon 30 to be advanced to the position in which the film 34 faces the support plate, and also allows for wetting of the support plate 20 resting on the first platen 124. The operative position allows proximity or even contact between the film 34 and the top side of the support plate 20, and this is prior to movement of the base 122 (e.g., upward) toward the second platen 128, whereby the first platen 124 and the second platen 128 come into contact.

In this second embodiment, two variants are considered:
the situation where the mobile base 122, carrying the first platen 124 (lower platen), with a second platen 128 mounted on a fixed support: it is then necessary to consider that the base 122 comprises a mobile part, that of the actuator of the equipment 100, and, that the support of the second platen 128 (upper platen) is the fixed base of the equipment 100 (no possible movement of the elements 126 and 129 of FIG. 9);
   and
the situation where the base 122 has a mobile part 125 (carrying the first platen 124) and having an actuator 126 with a mobile part 129 that carries the second platen 128.

In the present invention, with a ribbon 30 formed of a first layer 35 of a first material superimposed on a second layer 35 of a second material, this ribbon 30 is arranged so that the first material (the first layer 35) is adapted to face the support plate 20. This means that when the ribbon 30 extends between the supply reel 40 and the collecting reel 42, the first material (the first layer 35) of the portion of the ribbon 30 intended to form the film 34 faces the one of the first platen 128 and the second platen 124 that receives or is intended to receive the support plate 20 on which the film 34 is to be mounted.

The method of applying the film 34 to the support plate 20 is similar to that previously described in connection with the first embodiment, except for the following points:
Step 1: unchanged, except that in the case of a ribbon 30 with two layers 35 and 36, the first layer 35 with the material for forming the film 34 does not face upwards towards the second platen 128 as in the first embodiment, but this first layer faces downwards towards the first platen 124;
Step 2: is not implemented or a low position of the second platen 128 is used with activation of the vacuum through the passages 128a which maintains in place the good positioning of the ribbon 30 on the footprint 128a of the second platen 128;
Step 3: unchanged except that if the support plate 20 is mounted, it is mounted on the first platen 124;
Step 4: the support plate 20 is positioned on the first platen 124 in its lower or first position, with its second face 20b facing the first platen 124, by placing the centring hole 22 of the support plate 20 on a centring pin of the first platen 124 (not shown);
Step 5: the movable part 125 of the actuator disposed in the base 122 is risen until the moment when the support plate 20 comes into contact with the film 34, the first platen 124 and the second platen 128 resting with pressure between them;
Step 6: not applicable;
Step 7: unchanged;
Step 8: At this moment, the film 34 is stuck to the support plate 20, and is no longer connected to the rest of the ribbon 31, from which it has become detached, while still being positioned against (here below) the second layer 36. the movable part of the actuator 125 is lowered to the first position of the first platen 124:
Step 9: identical.

The examples illustrated in the figures and described relate to an equipment with a vertical back and forth movement of the piston of a cylinder, which piston forms the movable part of the actuator mentioned in the broadest conception of the present invention. In these examples, the first platen is a lower platen and the second platen is an upper platen, such that in the first position the second platen is raised relative to the first platen and in the second position the second platen is lowered relative to the first platen. In particular, in these illustrated examples, the second platen 128 is disposed above the first platen 124 and forms a top platen. Also, in the illustrated examples, the actuator 126 is disposed above the base 122, with the axis of the actuator 126 orthogonal to the top face of the first platen 124: in particular, the actuator 126 is an actuator with a linear motion piston, disposed above the base 122, said actuator defining a longitudinal axis intersecting with the first platen 124 and disposed orthogonally with the first platen 124. Other geometric arrangements or other types of motion remain possible within the scope of the present invention. In particular, a horizontal back and forth movement of the piston of the actuator (or more generally of the movable part of the actuator) can be envisaged, the first platen and the second platen then coming into contact by their facing faces which are then oriented vertically. It is also possible to envisage an inclined back and forth movement of the piston of the jack (or more generally of the mobile part of the actuator), the first platen and the second platen then coming into contact by their opposite faces which are then oriented in an inclined way, but always parallel to each other.

It can also be envisaged that the mobile part of the actuator is an arm pivoting around a horizontal axis with at its end a tooling carrying the support plate, this arm passing from a high, raised position, with the free face of the support plate turned towards the front, to a low, lowered position, with the free face of the support plate turned downwards and being horizontal, coming to stick to the film

The examples illustrated in the figures and described relate to equipment with a pneumatic cylinder as actuator: other types of cylinders or actuators are possible within the scope of the present invention, such as mechanical, electrical, electromagnetic, hydraulic, etc. actuators. Similarly, the examples illustrated in the figures and described relate to equipment with a linear motion actuator: other types of actuators or cylinders are possible within the scope of the present invention, such as rotary actuators, pendulum actuators, etc . . . .

The present patent application is not limited to the field of single-sided or double-sided treatment machines, but the equipment and method of applying film to a plate-like substrate can be used in other fields as well, including intermediate storage or pre-positioning of components of all types for subsequent operations.

### REFERENCE SIGNS USED ON FIGS

20 Support plate
20a First side of the support plate
20b Second side of the support plate
21 Through openings
22 Centering hole
24 Support plate with film=loading assembly
26 Part to be treated
30 Continuous ribbon
31 Ribbon without film
32 Pre-cutting line
34 Film
35 First layer
36 Second layer
40 Supply reel
42 Collecting reel
100 Equipment
102 frame
112 Upstream holder
114 Downstream holder
120 Assembly station
122 Base
123 Suction unit
124 First platen (lower platen-model 1)
124a Footprint
124b Passages
124′ First platen (lower platen-model 2)
124″ First platen (lower platen-model 3)
125 Actuator
126 Actuator (cylinder)
128 Second platen (upper platen model 1)
128a Footprint
128b Passages
128c Centering pin
128′ Second platen (lower platen-model 2)
128″ Second platen (lower platen-model 3)
129 Movable part of the actuator (piston of the cylinder)
130 Handle
140 Upstream guide roller
142 Downstream guide roller

1. Equipment for laying a film on a support plate having through openings, said equipment comprising:
an upstream holder suitable for serving as an axis for a supply reel carrying a continuous ribbon, a portion of which is suitable for forming a film intended to cover said support plate,
a downstream holder suitable for sewing as an axis for a collecting reel of the remaining portion of the continuous ribbon after separation of the film from the continuous ribbon,
an assembly station disposed between the upstream holder and the downstream holder comprising:
a base comprising a first platen,
an actuator with a movable part carrying a second platen connected to the free end of the movable part,
the second platen or the first platen being adapted to receive a support plate,
wherein the movable part is adapted to be reversibly moved from a first position, in which the second platen is spaced from the first platen, to a second position, in which the second platen rests on said first platen, and wherein the second platen is adapted to cooperate with said first platen in said second position of the movable part, to form a tooling capable of bringing said film and said support plate into contact when the portion of the ribbon forming the film is located between the second platen and the first platen, facing said support plate.

2. The equipment of claim 1, wherein the base includes a first platen defining a footprint having a contour which shape can cover at least all of the through openings of the support plate.

3. The equipment of claim 1, wherein said second platen is removable and wherein said first platen is removable.

4. The equipment of claim 2, wherein said second platen defines an footprint whose contour is superimposable on the contour of the footprint of the first platen, with contact between the contour of the footprint of the second platen and the contour of the footprint of the first platen in said second position of the movable part.

5. The equipment according to claim 1, wherein said actuator with a movable part is a cylinder with a linear motion piston, said movable part comprising said piston, said cylinder being disposed opposite facing the base, said cylinder defining a longitudinal axis intersecting with the first platen and disposed orthogonal to the first platen, wherein said second platen is connected to the free end of the piston rod.

6. Equipment according to claim 1, wherein said upstream holder carries a supply reel carrying a continuous ribbon, said ribbon being pre-perforated along at least one pre-cut line delimiting the contour of the film.

7. The equipment according to claim 1, wherein said continuous ribbon comprises a first layer of a first water-soluble or fat-soluble material covered with a second layer of a second material that is non-adherent to itself or to the first material, said ribbon being arranged such that the first material can face the support plate.

8. Equipment according to claim 1, in which the second platen comprises passages between its two faces, and the assembly station comprises a system for retaining the support plate, by vacuum, comprising a suction unit connected to said passages, said retaining system being able to allow the support plate, to be held on the second platen when said suction unit is activated.

9. The equipment according to claim 1, wherein said first platen is adapted to receive the support plate and in which the base is movable between a retracted position in which the first platen is more than 2 centimeters away from the passage zone of the section of the ribbon located between the upstream holder and the downstream holder, and an operational position in which the first platen is less than 1 centimeter away from said passage zone.

10. The equipment according to claim 1, wherein the second platen is disposed above the first platen and forms a top platen, and wherein the actuator is disposed above the base.

11. Equipment according to claim 1, in which said first platen comprises passages opening on its face turned towards the second platen, said equipment further comprising a system for holding the position of the film on the support plate by means of a vacuum, comprising a suction unit connected to said passages of the first platen, said holding system being capable of allowing the position of the film on the first platen to be held when said suction unit is activated.

12. Equipment according to claim 1, further comprising a pre-cutting station, disposed between the upstream holder and the assembly station, comprising cutting means arranged to allow the realization of a discontinuous pre-cut line in the ribbon, said discontinuous line following the contour of said film according to a shape able to cover the support plate.

13. The equipment according to claim 1, further comprising a frame on which the assembly station is mounted and two guide rollers including an upstream guide roller disposed parallel to the upstream holder, between the upstream holder and the base, and a downstream guide roller disposed parallel to the downstream holder, between the downstream holder and the base.

14. Equipment according to claim 13, wherein the lowest generatrix of said two guide rollers is located below the plane passing through the free face of the first platen or below and within 1 centimeter of said plane passing through the free face of the first platen.

15. The equipment according to claim 1, wherein said movable part is arranged such that when the second platen rests on first platen, the second platen exerts a pressure of at least 1 bar.

16. The equipment according to claim 5, wherein the actuator is a pneumatic actuator.

17. Equipment according to claim 1, further comprising a humidification unit located in the vicinity of the assembly station, and adapted to wet the face of the film facing the support plate or else adapted to wet the free face of the support plate when said support plate is mounted on the first platen or on the second platen.

18. Equipment according to claim 1, wherein the support plate is a part holder whose through openings form cells suitable for holding one or more parts.

19. The equipment according to claim 1, further comprising a vision control unit, comprising an image taking system and an image treatment and analysis system, the vision control unit being able to take views of the area of the first platen and/or the second platen.

20. Equipment according to claim 1, further comprising a loading unit adapted to bring a support plate in said assembly station onto the second platen or onto the first platen, when the movable part of the actuator is in the first position.

21. Equipment according to claim 1, further comprising an unloading unit adapted to take said support plate covered with said film out of said assembly station when the movable part of the actuator is in the first position.

22. A parts loading machine comprising the equipment according to claim 1, a receiving station for parts to be processed and a receiving station for support plates covered with said film.

23. A parts loading machine according to claim 22, further comprising a part loading station adapted to pick up a support plate covered with said film from the receiving station for support plate covered with said film, pick up a part from the part receiving station and place said part in an opening of said support plate.

24. Method of applying a film to a support plate having through openings, comprising the following steps:
a support plate is provided, forming a plate-shaped part holder,
a supply reel is provided, carrying a continuous ribbon, a portion of which is capable of forming a film intended to cover said support plate,
an equipment is provided, said equipment comprising:
an upstream holder on which said supply reel is mounted
a downstream holder on which is mounted a collecting reel suitable for receiving the remaining portion of the continuous ribbon after separation of the film from the continuous ribbon,
an assembly station disposed between the upstream holder and the downstream holder, said assembly station comprising:
a base comprising a first platen,
an actuator with a movable part
a second platen connected to the free end of the movable part,
wherein the movable part is able to move reversibly from a first position, in which the second platen is distant from the first platen, to a second position in which the second platen rests on said first platen, and
wherein the second platen is able to cooperate with said first platen, in said second position of the movable part, to form a tooling able to contact said film and said support plate
the movable part is placed in said first position
said support plate is mounted on the second platen or the first platen,
the continuous ribbon is placed in such a way that the portion of the ribbon forming the film is located between the second platen and the first platen,
the movable part is placed in said second position, whereby the support plate and the film come into contact with each other and a support plate covered with the film is obtained,
the movable part is placed in said first position and the support plate covered with the film is released from said assembly station.

25. The applying method according to claim 24, in which, before placing the portion of the ribbon forming the film between the second platen and the first platen, a discontinuous pre-cut line is made in the ribbon, said discontinuous line following the contour of said film in a shape suitable for covering the support plate.

26. The applying method according to claim 24, wherein said continuous ribbon comprises a first layer of a first water-soluble or fat-soluble material covered with a second layer of a second material which is non-adherent to itself and to the first material, said ribbon being arranged such that the first material is capable of facing the support plate.

27. The applying method according to claim 26, wherein said equipment further comprises a humidification unit located in the vicinity of the assembly station, and capable of wetting the face of the film facing the support plate, or capable of wetting the free face of the support plate when said support plate, is mounted on the first platen or on the second platen and when the movable part is in said first position.

28. The applying method according to claim 24, in which said first platen comprises passages opening on its face turned towards the second platen, said equipment further comprising a system for maintaining the position of the film on the support plate, by means of vacuum, comprising a suction unit connected to said passages of the first platen and wherein, before placing the movable part, in said second position, said suction unit is activated, whereby the position of the film, on the first platen is maintained, and the activation of said suction unit is maintained while the movable part is in said second position.

29. The applying method according to claim 24, wherein said actuator with a movable part is a cylinder with a linear motion piston, said movable part comprising said piston, said cylinder being disposed opposite facing the base, said cylinder defining a longitudinal axis intersecting with the first platen and disposed orthogonal to the first platen, wherein said second platen is connected to the free end of the piston rod.
